(19) United States
(12) Patent Application Publication
(10) Pub. No.: US 2016/0004941 A1
(43) Pub. Date: Jan. 7, 2016

(54) METHOD FOR CALCULATING SUBSTITUTION COLORS FOR SPOT COLORS

(71) Applicant: HEIDELBERGER DRUCKMASCHINEN AG, HEIDELBERG (DE)

(72) Inventor: GUENTER BESTMANN, ALTENHOLZ (DE)

(21) Appl. No.: 14/792,784

(22) Filed: Jul. 7, 2015

(30) Foreign Application Priority Data
Jul. 7, 2014 (DE) 102014010061.8

(51) Int. Cl. G06K 15/02; G06F 3/12

(52) U.S. Cl. CPC G06K 15/1822; G06K 15/1878; G06F 3/122; G06F 3/1254; G06F 3/1276; G06K 15/027

(57) ABSTRACT

A method for calculating substitution colors for spot colors by using a computer for computer-aided color control of a four-color printing process in a printing machine includes creating a set of characterization data, which describe the relationship between tonal values of the process colors CMYK used and resultant printed color values, by using the computer, adapting to the printing process and interpolating the set of characterization data by using the computer and calculating the substitution colors including or formed of two chromatic and an achromatic color from the adapted and interpolated characterization data with a basic condition by using the computer. The calculated substitution colors are used in the computer-aided color control of the four-color printing process to process a current print job.

### CROSS-REFERENCE TO RELATED APPLICATION

This application claims the priority, under 35 U.S.C. §119, of German Parent Application DE 10 2014 010 061.8, filed Jul. 7, 2014; the prior application is herewith incorporated by reference in its entirety.

### BACKGROUND OF THE INVENTION

### Field of the Invention

The present invention relates to a method for calculating substitution colors for spot colors.

The invention pertains to the technical field of electronic reproduction technology.

In the field of reproduction technology, original artwork containing all elements to be printed such as text, graphics, and images are created for print pages. In color printing, a separate original artwork containing all elements to be printed in the respective color is created for every color. Four-color printing uses the process colors cyan (C), magenta (M), yellow (Y), and black (K). The individual original artwork for a respective color is referred to as a color separation. Printing plates are exposed in accordance with the original artwork in specific exposure devices. Alternatively, the original artwork is directly transmitted to a digital printing machine in the form of digital data. There, the data of the original artwork are used, for instance, to expose printing plates in an exposure unit integrated in the printing press. Immediately afterwards, production printing is started. In addition, there are digital printing machines that do not need printing plates because they rely on electrophotographic or inkjet printing processes.

In accordance with the heretofore known prior art, the original artwork is electronically reproduced. Images are scanned in a color scanner and the resultant data are saved in digital form. Texts are created using word processing programs and graphics are created using drawing programs. A layout program is used to combine image, text, and graphics into a page to be printed. The data of multiple pages to be printed are then provided with the data of further elements such as register crosses, cutting marks, and fold marks as well as print control fields to form complete original artwork for a sheet to be printed. The data formats most commonly used to describe the original artwork are the PostScript and PDF (Portable Document Format) page description languages. In a first step carried out prior to the transfer of the original artwork to a film or printing plate, a Raster Image Processor (RIP) converts the PostScript or PDF data into color separation values for the C, M, Y, K color separations. In this process, for every image dot, four color separation values are created as tonal values in a range between 0% and 100%. The color separation values are a measure for the color densities at which the four process colors cyan, magenta, yellow, and black are printed onto the printing substrate. In special cases in which more than four colors are involved, every image dot is described by a number of color separation values corresponding to the number of print colors. The color separation values may for instance be saved as a data value of 8 bit per image dot and color, resulting in a subdivision of the value range from 0% to 100% into 256 tonal steps.

In general, at first, the colors of the elements on a page are not defined in the CMYK color system of process colors but in a different color system. For instance, in a scanner, color filters divide the images into the color components red, green, and blue (RGB), i.e. into the components of a three-dimensional color space. Thus, prior to the transfer of the original artwork on color separation films or printing plates, the image data need to be converted from the RGB color space of the scanner to the CMYK color space of the printing process to be used. The same applies to images that have been digitally photographed.

Such color space conversions are needed in the field of reproduction technology because the devices and processes are subject to certain limitations and particularities in terms of the representation and reproduction of the colors. Those limitations and particularities vary between devices and processes. Thus there are different color spaces for the various devices and processes such as scanners, monitors, proofers, printing processes, etc. to provide an optimum description of the color properties of the respective device or process. Those color spaces are referred to as device-dependent color spaces. In addition to the device-dependent color spaces, there are device-independent color spaces that are based on the human visual abilities of a so-called standard observer. Such color spaces for instance include the CIE 1931 XYZ color space (XYZ color space for short) defined by the International Commission on Illumination CIE (Commission Internationale d′Éclairage) or the CIE 1976 L*a*b* color space (Lab color space for short) derived therefrom, which has become more widely accepted in the art. If one wants to know whether two colors are perceived to be identical or different by the human eye, it is sufficient to measure the XYZ or the Lab color components. The Lab color components form a three-dimensional color space with a lightness axis (L) and two color axes (a, b), which one may imagine in the plane of a color circle with a center through which the lightness axis passes. The Lab color components are related to the XYZ color components through non-linear conversion equations.

A device or a color-processing process may be characterized in terms of its color properties by correlating all possible value combinations of the associated device-dependent color space (tonal values) with the corresponding Lab color components (color values) that the human eye perceives for the color created by those tonal value combinations. For a printing process, every one of the various CMYK tonal value combinations generates a different printed color. A color measurement device may be used to determine the Lab components of the printed colors and to assign them to the CMYK tonal value combinations. Such an association that establishes a relationship between the device-dependent colors generated by a device or process and a device-independent color space (XYZ or Lab) is also referred to as a color profile, in the case of a printing process as an output color profile. The definition and data formats for color profiles have been standardized by the ICC (International Color Consortium) (Specification ICC.1 2006-05) and by ISO (ISO ISO15076-1:2005). In an ICC color profile, the correlation between the color spaces is saved in both directions, for instance the correlation Lab=f1 (CMYK) and the inverted association CMYK=f2 (Lab). The correlation defined in a color profile may be implemented with the aid of a table memory. For instance, if the CMYK tonal values of a printing process are to be correlated with the Lab color values, the table memory needs to have a memory space to save a correlated Lab color value for every possible value combination of the CMYK tonal values. A disadvantage of that simple correlation process is, however, that the table may require a lot of memory space. If every one of the CMYK tonal values has 256 density steps, there are 256⁴=4,294,967,296 possible value combinations of the CMYK tonal values. Therefore, the table memory needs to have 4,294,967,296 memory cells with a word length of 3 bytes or 6 bytes (one or two bytes for L, a, b). In order to reduce the size of the table memory, a combination of a table memory and an interpolation process is used to describe a color profile and to implement a corresponding color space transformation. The table memory only saves the correlated Lab components for a coarser, regular grid of nodes in the CMYK color space. For CMYK tonal values located between the grid nodes, the correlated Lab color values are interpolated from the saved Lab color values of the neighboring nodes.

As described above, specific print tables (ICC color profiles) are used for color separation purposes. Those tables additionally include process-related basic conditions such as the color composition (total area coverage, maximum black, composition of black) and the representation of non-printable color values (gamut mapping). While printing tables for CMYK systems are easy to compute using the conventional colorimetric methods that becomes cumbersome and complex for systems with spot colors and multicolor systems.

The printing tables are calculated from characterization data of a printing process. The characterization data are the definition of an unequivocal correlation between digital tonal values and measured color values in the printed image (tonal values CMYK/color values CIEXYZ or CIELAB). The measured color values may, in particular, be saved as spectrums. The characterization data may also be used for process control and process calibration.

In the prior art, the characterization data for CMYK systems are determined by using a test element in accordance with ISO 12642-2:2006 or by using corresponding manufacturer-specific test elements. The latter is necessary, in particular, for multicolor systems.

German Patent Application DE 10 2004 001 937 A1, corresponding to U.S. Pat. No. 7,032,517, for instance discloses determining an ICC color profile by creating four test forms, obtaining respective characterization data from the test forms, and creating corresponding table memories that describe the correlation between the color values of a device-independent color space and the print-related color space. The use of four test forms is due to the fact that spot colors are to be replaced by using secondary print colors. In addition, matrix operations are proposed as an example of factoring-in non-linear changes of the tonal value steps, i.e. additional gradation corrections are factored-in, e.g. as a function of the dot gain of the individual print dots.

A disadvantage of that method is, however, that it is highly complex because due to the use of spot colors, the test forms need to contain many color fields to be able to cover all required color combinations. In the color toolbox that has been used so far, two test tables, each having 1230 color fields (2460 color fields in total), are printed and measured for a five-color printing process. That needs to be done for every spot color. That is a complex process that becomes even more complex for six or seven color printing (2816 and 2520 color fields in the current Color Toolbox). Thus, the print tables required to correlate the color values become rather cumbersome. In order to generate an entire multicolor print with all combinations, a total of 15 different test tables need to be printed and measured (one for CMYK, 2 for every single spot color, 2 for every combination of 2 spot colors, and 2 for all three spot colors together). In general, the test tables are measured multiple times to obtain an average, which further increases the work to be done.

German Patent Application DE 10 2010 007 858 A1, corresponding to U.S. Pat. No. 8,654,395, discloses a test element that provides actual spectral data. Subsets of those actual data are used to determine tonal value and/or dot gain curves, parameters for a model of the printing process to determine spectrums of colors printed on top of each other (CMYK) and adapted input variables (C_{b}M_{b}Y_{b}K_{b}) factoring in the tonal value increase to determine corrected tonal values (C′M′Y′K′) and/or the spectrums thereof in a computing unit based on the model. In order to calculate characterization data, only a few color fields are required. However, that method is not suited for use with spot colors.

Spot colors or special colors are used in the printing process if colored design features such as corporate colors, logos and graphics are to be reproduced with a high degree of accuracy. For reasons of efficiency in terms of costs and complexity, it is often expedient to print those special colors by using the process colors cyan, magenta, yellow, and black that are already available or, in the case of multicolor printing, by using the additional color space enhancing process colors red (orange), blue and/or green.

Those substitution colors may be composed manually. For some spot color systems (PANTONE®) for four-color printing (CMYK) and for multicolor printing including six printing colors (PANTONE Hexachrome: CMYK, Orange, Green), however, there are substitution tables. Yet those substitution colors are not widely used because they are only applicable in a few very specific printing processes and are in general composed of more than two chromatic colors and black. The results are unsatisfactory and are only used if no other information is available. In addition, there are applications in which the corresponding substitution colors are computed in the prepress stage in the workflow system (e.g. Heidelberg PRINECT®) based on the available printing profiles (ICC profiles). In that case, too, the substitution colors are in general composed of more than two chromatic colors and black and there is no way of influencing the results of the conversion.

Moreover, there are applications in which the spot colors are analyzed and the substitution colors are selected from a number of different profiles. In that case an attempt is made to determine a representation that has minimum total area coverage. That method is complex and requires multiple printing profiles.

A disadvantage of all of the methods is that process stability is not optimal due to the fact that the chromatic colors and black are printed together. It is known that a replacement of the graying proportions of the chromatic colors by proportions of the achromatic process color leads to a higher degree of stability in the printing process.

A disadvantage of all known methods of the prior art is that the current white of the printing substrate is not sufficiently factored in. The representation of the substitution colors in general only refers to a reference printing substrate.

Another disadvantage is that in an ICC profile, individual color areas may be modified, resulting in wrong substitution colors. As a consequence, it is expedient to start from the forward model of the ICC profile and/or on the original characterization data.

### SUMMARY OF THE INVENTION

It is accordingly an object of the invention to provide an expedient method for calculating substitution colors for spot colors, which overcomes the hereinafore-mentioned disadvantages of the heretofore-known methods of this general type and which is more efficient and less complex than the heretofore known methods for calculating substitution colors for spot colors for color control purposes in a printing process in a printing machine.

With the foregoing and other objects in view there is provided, in accordance with the invention, a method for calculating substitution colors for spot colors by using a computer for computer-aided color control of a four-color printing process in a printing machine comprising the following steps:
1. creating a set of characterization data, which describe the relationship between tonal values of the process colors CMYK used and resultant printed color values, by using the computer;
2. adapting to the printing process and interpolating the set of characterization data by using the computer;
3. calculating the substitution colors including two chromatic and an achromatic color from the adapted and interpolated characterization data with a basic condition by using the computer; and
4. using the calculated substitution colors in the computer-aided color control of the four-color printing process to process a current print job.

What is crucial for the method is the calculation of the substitution colors from the characterization data based on a search process with basic conditions. In this case, the characterization data describe the relationship between the color values, which represent the resultant, i.e. printed LAB values measured by color measuring devices, and the tonal values, which describe the combination of the CMYK tints used in the printing method (plus possible spot colors plus printing substrate), with which the printing machine is intended to realize the desired target color values. Characterization data can be introduced into a method according to the invention in various ways. In one preferred variant, in accordance with the prior art already acknowledged, they are created anew from test elements, i.e. test elements having all target colors are printed and the color values of the test element are measured by a densitometer and/or spectrometer. The measured values are then digitized and linked by a computer, e.g. the control computer of the printing machine, with the tonal values (CMYK+spot colors) set in the printing machine, which tonal values were required for printing the color values. To put it in a simplified way, this gives rise to the characterization data. This digital characterization data are then also adapted to the printing process and interpolated by a computer—i.e. the printing substrate, for example, is included since it likewise has an influence on the color values and missing values for the relationship tonal value ⇄ color value are added. With these data, the substitution colors for the spot colors can then be calculated in the context of the actual invention. In four-color printing they are formed of or include an achromatic color, black, and two chromatic colors, e.g. cyan and yellow. The missing chromatic color here is the complementary color with respect to the substituting spot color—and that is to say magenta in the case of a green spot color. Accordingly, the two chromatic colors cyan and yellow are used for mixing the substitution color. Once the substitution colors have been determined, they are incorporated in the digital color control process of the printing machine. The answer to the question whether the spot colors or the substitution colors are then used depends on the operator's settings of the machine.

Advantageous and therefore preferred further developments of the method according to the invention will become apparent from the associated dependent claims and from the description and with the associated drawings.

In accordance with a further preferred development, the characterization data are established by an evaluation of printed test elements in accordance with ISO 12642-2 with 1617 color fields, wherein the evaluation takes place by the printed test elements being measured by color measuring devices, in particular densitometers and spectrometers, and the measured color values obtained are subsequently digitized and are saved in conjunction with the process colors CMYK used as a set of characterization data in a manner accessible to the computer.

In order to create the set of characterization data, the use of printed test elements is appropriate. Of course, for the purpose of calculating substitution colors, those test elements must also include the spot colors to be substituted. One of the test elements is the test element with 1617 color fields that is known from the prior art and standardized in accordance with ISO 12642-2.

With the objects of the invention in view, there is also provided a method for calculating substitution colors for spot colors by using a computer for computer-aided color control of a four-color printing process in a printing machine comprising the following steps:
1. selecting a set of characterization data, which describe the relationship between tonal values of the process colors CMYK being used and resultant printed color values, by using the computer, from a pool of existing, standardized sets of characterization data which are stored in a memory;
2. adapting to the printing process and interpolating the set of characterization data by using the computer;
3. calculating the substitution colors including two chromatic and an achromatic color from the adapted and interpolated characterization data with a basic condition by using the computer; and
4. using the calculated substitution colors in the computer-aided color control of the four-color printing process to process a current print job.

In this variant of the method according to the invention, the necessary characterization data are not created anew by the use of a printed test element, but rather are selected from a pool of saved, that is to say already existing, characterization data by using the computer. In this case, the characterization data were created for previous printing processes with similar colors used and were saved for further use. In this case, the computer responsible for the color control of the printing process selects from the pool that set of characterization data which is the most suitable for the current printing process. This is usually the set where the color values that are to result in the set deviate the least from the target values to be achieved in the current printing process.

With the objects of the invention in view, there is furthermore provided a method for calculating substitution colors for spot colors by using a computer for computer-aided color control of a four-color printing process in a printing machine comprising the following steps:
1. selecting a suitable ICC profile, in which an assignment of tonal values of the process colors CMYK being used to the color spaces of the resultant printed color values is saved in a tabular fashion, from a pool of existing standardized ICC profiles which are stored in a memory;
2. adapting to the printing process and interpolating the set of characterization data by using the computer;
3. calculating the substitution colors including two chromatic and an achromatic color from the adapted and interpolated characterization data with a basic condition by using the computer; and
4. using the calculated substitution colors in the computer-aided color control of the four-color printing process to process a current print job.

Instead of characterization data, the relationship between tonal values of the process colors CMYK being used and resultant printed color values can also be derived by using an ICC profile. ICC profiles include tables describing this relationship. They can also be created from the characterization data. In this variant of the method according to the invention, various ICC profiles are saved in the pool and the computer selects an ICC profile suitable for the current printing process and adapts it to the printing process. The selection is made according to the same criteria as those of the set of characterization data (e.g. matching the target color values). Otherwise, this variant of the method according to the invention corresponds to the previous variants.

With the objects of the invention in view, there is additionally provided a method for calculating substitution colors for spot colors by using a computer for computer-aided color control of a four-color printing process in a printing machine comprising the following steps:
1. creating a multicolor profile of characterization data, which describe the relationship between tonal values of the process colors CMYK used and resultant printed color values, by using the computer;
2. adapting to the printing process and interpolating the multicolor profile of characterization data by using the computer;
3. calculating the substitution colors including two chromatic and an achromatic color from the adapted and interpolated multicolor profile with a plurality of basic conditions by using the computer; and
4. using the calculated substitution colors in the computer-aided color control of the multicolor printing process to process a current print job.

The method according to the invention can also be used for calculating substitution colors for spot colors in multicolor printing. Multicolor printing in this case means that more than four colors (CMYK or CMGK with spot color green) are used for printing. That usually takes place by the use of spot colors (e.g. CMYGK with G as spot color green in five-color printing). The main difference with respect to the standard variant of the method according to the invention is that the characterization data are significantly more complex since the relationship between tonal values ⇄ color values becomes more complex as a result of the additional color(s). Here a multicolor profile of characterization data which maps the more complex relationship is then required. By contrast, the calculation of the substitution color is still carried out in the computer with an achromatic color, black, and the two chromatic, non-complementary colors. A plurality of basic conditions is required, however, as a result of the multicolor profile of characterization data.

In accordance with another preferred development, the characterization data are to be established by an evaluation of minimized printed test elements, wherein the evaluation takes place by the printed test elements being measured by using color measuring devices, in particular densitometers and spectrometers, and the measured color values obtained are subsequently digitized and are saved in conjunction with the process colors CMYK used as a set of characterization data in a manner accessible to the computer, and wherein the missing color values of the minimized printed test element are calculated by the computer by using segmented spectral Neugebauer equations.

Since multicolor profiles of characterization data are required when the method according to the invention is used in multicolor printing, the creation of the characterization data by printing ink test elements becomes correspondingly more complex as a result of the use of the additional spot colors, which, after all, must likewise occur in the test element. Therefore, the use of minimal printed test elements that is known from the prior art is appropriate. Here, in contrast to test elements with 1617 color fields that are standardized in accordance with ISO 12642-2, the method does not implement all or most combinations of the colors used in the different screening stages, that are either only specific, selected combinations. This entails a significantly reduced complexity, since fewer tonal and color value combinations have to be measured and evaluated. Here, the missing values are interpolated by using segmented spectral Neugebauer equations.

In accordance with an added preferred development, for the calculation of the substitution colors missing color values are calculated by using multilinear interpolation.

Since ICC profiles and standardized characterization data sets usually do not contain all color values required for a reliable calculation of the substitution colors, the missing color values have to be added by the use of multilinear interpolation methods.

In accordance with an additional preferred development, the determined substitution colors are saved in a table to be used in a workflow system.

Once the tonal value combinations of the determined substitution colors have been calculated, it is practical to save them in a table for them to be reused later on. The workflow system is a software system that controls the entire printing process, usually from prepress to postpress. One example for such a workflow system is the Heidelberg Prinect® Workflow System. This further development applies both to the disclosed method for four-color printing processes and to the disclosed method for multicolor printing processes.

In accordance with a concomitant preferred development, the method is integrated into a workflow system as an integral part thereof.

For reasons of an efficient processing of the printing process, it is expedient to integrate the disclosed method into the software of the workflow system as a part of the latter. This further development is likewise usable with both of the disclosed methods.

The method and further developments thereof that are advantageous in functional terms will be explained in more detail below with reference to the associated drawings and based on at least one preferred exemplary embodiment. In the drawings, corresponding elements have the same reference symbol.

Other features which are considered as characteristic for the invention are set forth in the appended claims.

Although the invention is illustrated and described herein as embodied in a method for calculating substitution colors for spot colors, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, top-plan view of a four-color test element known from the prior art;

FIG. 2 is a top-plan view of a combined five-color minimized test element including the spot color green;

FIG. 3 is a top-plan view of a simplified representation of an ICC color profile;

FIG. 4 is a top-plan view of an example of a color table;

FIG. 5 is a flow chart of the method of the invention; and

FIG. 6 is a longitudinal-sectional view of an example of an offset printing machine which is used in the method of the invention.

### DETAILED DESCRIPTION OF THE INVENTION

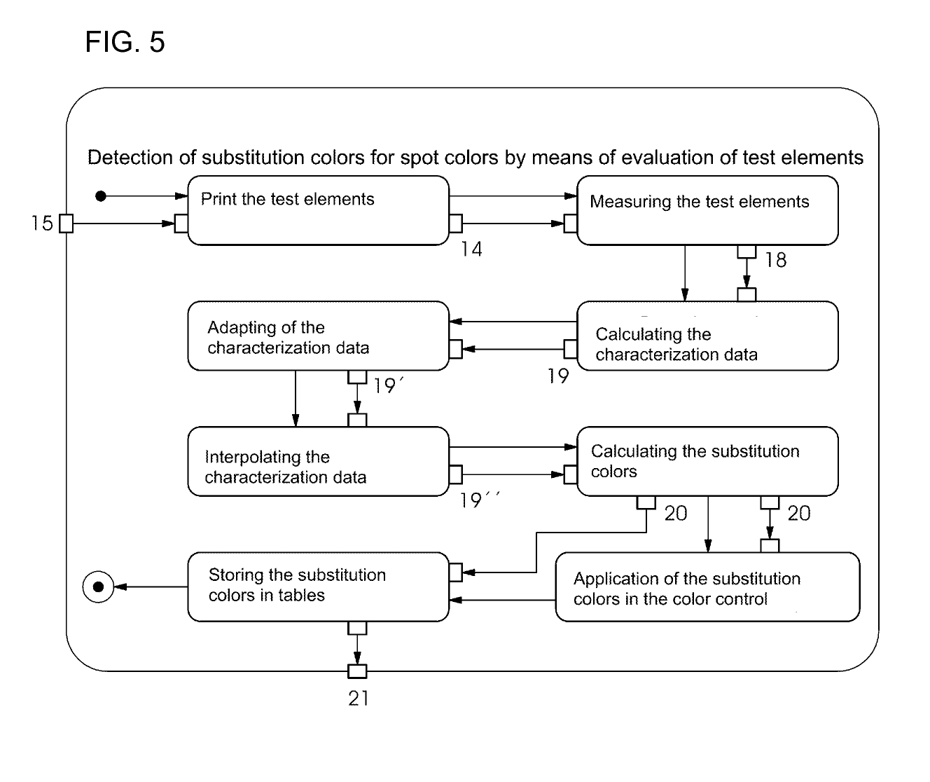

Referring now in detail to the figures of the drawings, it is seen that the preferred exemplary embodiment of the disclosed method is based on the algorithms of the Prinect Color Toolbox for generating multicolor profiles to convert a set of non-standardized characterization data 19 into a forward model. This forward model allows the determination of suitable characterization data 19″. The implementation of the disclosed method in accordance with the flow chart in its preferred embodiment variant, as illustrated schematically in FIG. 5, is realized in the digital area by the control computer of the printing machine and is subdivided here into a plurality of method steps:

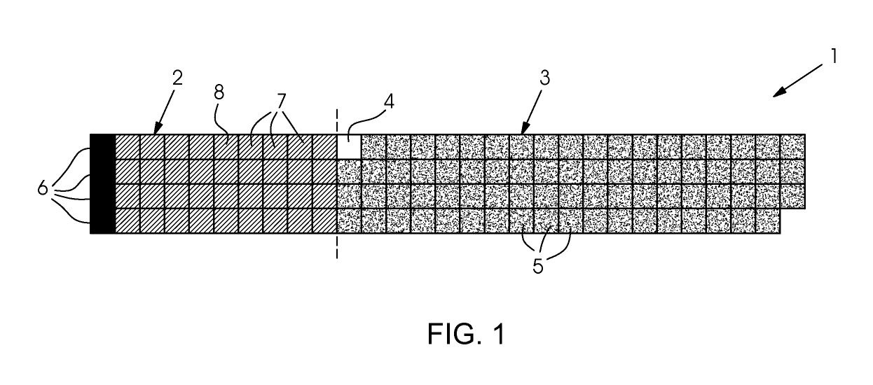

At first, characterization data 19 in accordance with ISO 12642-2 need to be established. For four-color printing, color management, and the data exchange of documents, unequivocal correlations between the digital tonal values and the printed color values are necessary. In general, the digital tonal values are available as CMYK process colors. In packaging printing, individual process colors or several process colors may be replaced by product-specific colors, i.e. special or spot colors 9, 10, 11, 12. The process color magenta, for instance, may be replaced by a red spot color. The printed color values depend on the printing process (sheet-fed offset printing, web-fed offset printing), on the process standard (coloration of the solid areas, dot gain of the process colors) and on the materials that are used (printing substrate, printing ink). The digital tonal values (screen percent) and the associated color values (CIELAB, CIEXYZ and/or spectrums) then form the characterization data 19. The characterization data 19 are used to obtain color profiles for the separation of images and graphics and to obtain guide values for process calibration and process control. Characterization data sets 19 are determined with the aid of test elements 1 by using the test elements 1 being printed out on a defined substrate and measured by color measuring devices, such as densitometers and/or spectrometers, and digitized. The characterization data sets 19 thus created then also have to be adapted to the printing process being respectively used. This becomes necessary, for example, if the paper used in the later printing process has a different paper white value than the paper used for printing the test element 1. One example of a test element 1 is the test element 1 which is standardized in ISO 12642-2, illustrated in a simplified form in FIG. 1, and which is formed of defined color fields 8 of the CMYK process colors 9, 10, 11, 12. In this case, the test element 1 is divided into two area parts 2, 3. The first area part 2 contains the solid tone fields 6 in the CMYK process colors 9, 10, 11, 12, and the tonal value color fields 7, which contain the solid tone fields 6 in gradated screening. The second area part 3 contains mixed color fields 5, in which the CMYK process colors 9, 10, 11, 12 are intermixed and represented in gradated screening. The minimum screening of 0% then produces the white color field 4. In addition to this standard test element 1, there may be further manufacturer-specific test elements and further developments of ISO 12642-2 for general applications with an even finer scanning of the color space. The tonal values of ISO 12642-2 form a regular grid. For a black value of K=0%, the CMY tonal values are 0%, 10%, 20%, 30%, 40%, 55%, 70%, 85%, and 100%. For higher black values of K=20%, 40%, 60%, 80% and 100%, there are fewer CMY tonal values to prevent the number of color fields from getting too high. In this regular grid, simple interpolation methods (tetrahedron interpolation, tri-linear interpolation) may be used to determine intermediate values for any desired tonal value combination. If required, greater accuracy may be achieved by using the segmented Neugebauer equations or, for spectral color values, the spectral segmented Neugebauer equations.

If the creation of the characterization data sets 19 seems too much effort, standardized characterization data sets that are already available may be used, which then need to be adapted for the current printing process. Such standardized characterization data sets for defined printing conditions have been established for process standards common in the U.S. and Germany. In addition, there are individual characterization data sets of various organizations, print shops, and publishing houses. The data sets refer to a defined paper with a specific paper white value. In practice, papers of different paper white values are frequently used. Known methods are available for adapting the characterization data 19′ in a good approximation. One method is described in ISO standard ISO 13655, another method in ISO standard 15076. Both methods are suitable if paper white values and paper properties do not differ widely. Otherwise, specific characterization data need to be generated.

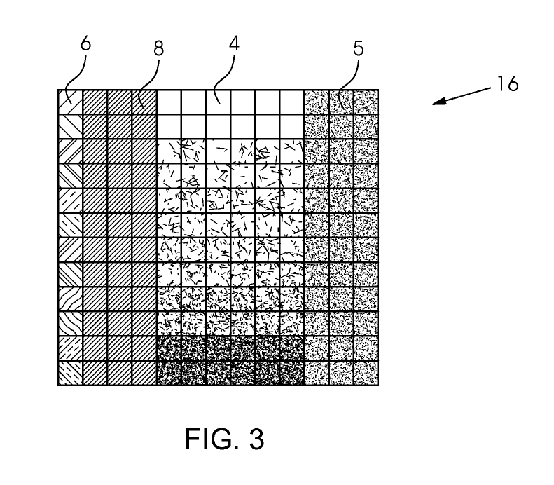

In accordance with an alternative embodiment, the characterization data 19 may be directly generated from ICC color profiles 16. A simplified diagram of such an ICC profile is shown in FIG. 3. Several tables 17 have additionally been embedded into the ICC color profile 16, among others a table 17 containing interpolated color values of a characterization data set 19. This table 17 may be extracted from a profile 16 and may be reduced to a characterization data set 19.

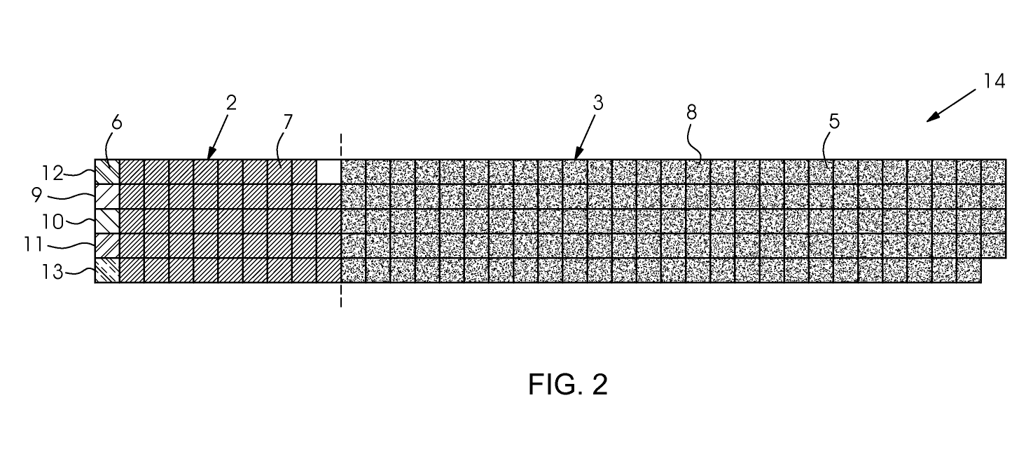

In accordance with another alternative embodiment, the characterization data 19 are obtained by using a minimized, optimized test element 14. With the aid of the modified and segmented spectral Neugebauer equations, standardized characterization data sets may be calculated from this test element 14. These data sets are characterized by the fact that spectrums for the individual color values are available and the spectrums of any desired tonal value combinations may be calculated. The calculation of the spectrums of the substitution colors for the spot colors in particular is possible. For printing processes with more than four printing colors, corresponding optimized test elements 14 may be generated, in particular optimized test elements 14 with fewer color fields. German Patent Application DE 10 2004 001 937 A1, corresponding to U.S. Pat. No. 7,032,517, describes a method that makes do with a similarly low number of color fields. There, a respective one of the chromatic printing colors CMY is replaced by a complementary printing color. That method may analogously be applied by using the minimized test element 14 in accordance with German Patent Application DE 10 2010 007 858 A1, corresponding to U.S. Pat. No. 8,654,395. FIG. 2 shows such a minimized test element 14 that includes four colors and a spot color 13 and makes do with very few color fields 8.

For a calculation of the substitution colors, it is necessary to determine potentially missing color values by interpolation. For this purpose, multi-linear interpolation processes above all are a possibility. Multi-linear interpolation is a weighted interpolation of the color values of the corner points of the surrounding cube about the searched-for tonal value. The corner points are determined in a search process. Let us take an example involving the tonal values known from the first step of the method for the three-dimensional case (CMY tonal values 0%, 10%, 20%, 30%, 40%, 55%, 70%, 85%, and 100%). For C=15%, M=26%, and Y=74%, we get the corner points C=10 and 20%, M=20 and 30% and Y=70 and 85%. The relative coefficients in terms of the cube origin CMY=10/20/70 then are Ck=(15−10)/(20−10), Mk=(26−20)/(30−20), and Yk=(74−70)/(85−70). Every corner point of the cube is assigned a linear combination a (CMY) of the coefficients Ck, Mk, Yk and 1−Ck, 1−Mk, 1−Yk, respectively, and the values of the corner points are multiplied by this combination and totaled.

a0(CMY)=(1−Ck)×(1−Mk)×(1−Yk)

a1(CMY)=(Ck)×(1−Mk)×(1−Yk)

a2(CMY)=(1−Ck)×(Mk)×(1−Yk)

a3(CMY)=(Ck)×(Mk)×(1−Yk)

a4(CMY)=(1−Ck)×(1−Mk)×(Yk)

a5(CMY)=(Ck)×(1−Mk)×(Yk)

a6(CMY)=(1−Ck)×(Mk)×(Yk)

a7(CMY)=(Ck)×(Mk)×(Yk)

f(CMY)=a0×f(C=10,M=20,Y=70)+a1×f(C=20,M=20,Y=70)+ . . .

The next step now is determining the color combinations to be found of the substitution color. Spot colors are colorimetrically described by a CIE 1976 L*a*b* (in short CIELAB) color value. Now the task is to find tonal value combinations of the substitution color that match this color value. If more than three colors are used in the printing process, the result is no longer unambiguous. For dark spot colors, for instance, there are corresponding combinations of CMY for a range of black color values that will lead to the same tonal value. It is known that a large proportion of black leads to a stabilization in the print because the result is less susceptible to inking fluctuations in the individual printing units. At the same time, a large proportion of black reduces the total amount of used being ink. Now the task is to find the substitution color that has the greatest proportion of black and the greatest proportion of the suitable color space enhancing process color. The problem is the equivalent of removing the chromatic colors C, M, Y that have the smallest color proportion from the substitution color. A further basic condition is that the color difference between the spot color and the substitution color remains below a defined threshold or, if the spot color lies outside the reproducible color space, is minimized. An optimum tonal value combination for the substitution color is found in a search process with basic conditions in the characterization data 19 or in the forward model of the multicolor profile. The method is known from German Patent Application DE 10 2011 012 806 A1, corresponding to U.S. Pat. No. 8,537,420, and has been enhanced for the present application.

Generally it holds that color space transformations from M to N with M=3, N>M are overdefined, that is there is more than one solution. Therefore N−M basic conditions need to be defined. Basic conditions in a four-color printing process are, for instance, a defined black (K), a maximum black at a minimum color difference between the spot color and the substitution color, or a defined fixed chromatic color (C, M, or Y), which may be zero. Basic conditions in a printing process with more than four colors are, for instance, a defined, fixed black (K), a maximum color space enhancing process color orange, green, or blue, or two defined fixed chromatic colors out of C, M, or Y, which may be zero. In the given application, the minimum chromatic color out of C, M, and Y is to be minimized (set to zero). This automatically results in a maximization of black (K) 12. In general, the minimum chromatic color is the complementary printing color of the spot color. For a spot color from the red color range, this is the process color cyan (C), for blue colors, this is the process color yellow (Y), and for green colors it is the process color magenta (M). If this decision cannot be made unambiguously (for a yellow color, cyan or magenta may be minimized or set to zero), additional basic conditions such as the minimum color difference need to be taken into account.

In a further application, black 12 and one of the color space enhancing chromatic colors are to be maximized. This in general causes two of the usual chromatic colors 9, 10, 11 to become zero. Thus almost any spot color may be represented by a color space enhancing chromatic color (O, G, B), a standard chromatic color (C, M, Y) 9, 10, 11 and black (K) 12.

The method will be explained on the basis of an example. Let us assume that we have a red color. At the beginning, a value combination of C, M, Y, K, and O may be determined from the multicolor profile (five-color profile with orange as an additional process color) in a conventional calculation.

In a first step, black 12 is maximized so that one of the chromatic colors C, M, Y 9, 10, 11 becomes zero. Typically, this will be the color component C, M, Y 9, 10, 11 that has the lowest value. This value, which may be Y 11, for instance, is set to zero. The additional process color, O in the present example, is maintained constant. In this first step, we take the remaining tonal values of M, C, and K as a starting value. These tonal values are used to calculate the associated color value 18 and the color difference to the value of the spot color 13 from the characterization data 19 or the forward model of the multicolor profile. In a further step, one of the components, for instance M 10, is varied by a defined amount (e.g. +2% and −2%) and the color differences to the value of the spot color 13 are calculated. The value that belongs to the smallest color difference is taken as the new value for M 10. This process is then carried out for C 9 and K 12. This second step is repeated until M, C 10, 9 and K 12 do not change anymore. Then the defined amount is divided in half, here to +1% and −1%, and the process of step two is carried out again. The amount is divided by half until it drops below a lower threshold of 0.05%, for instance. The then resultant values of MCK 10, 9, 12 are the desired intermediate result and the substitution color of the spot color 13 in this characterization data set 19″.

In the next step, only black (K) 12 is maintained constant, likewise the process color Y 11 from the step described above. Then the value of the process color O is successively increased by an amount, for instance +2%. Then the iterative process described above is used to search for a new value combination M, C 10, 9 for which the difference between the color value of the spot color 13 and of the calculated color is minimized and at the same time not greater than the difference at the beginning of the calculation. If the difference increases, 2% are subtracted and the method is continued with half of the percentage, here +1%. This process is continued until the percentage is below a threshold such as 0.05%.

Optimally, the result is now a set of three color values, i.e. black (K) 12, the color space enhancing process color (O), and one of the three original process colors (C, M, or Y) 9, 10, 11.

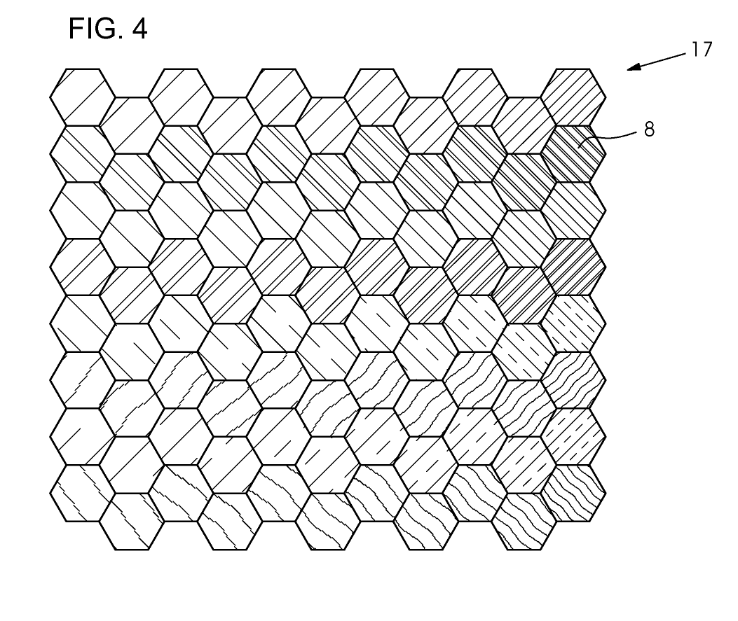

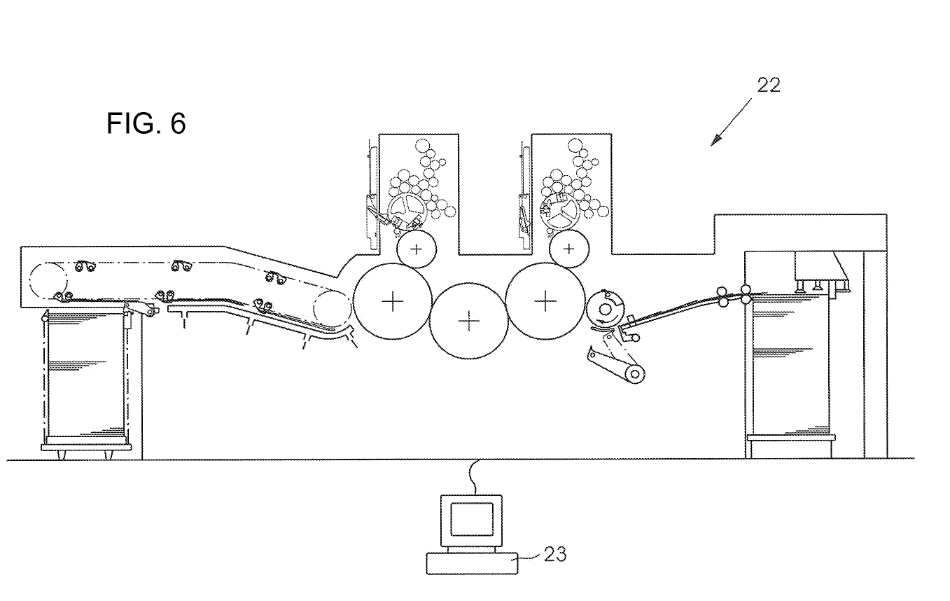

If the required combination of process colors to replace the desired spot color 13 has been determined in this way, this substitution color 20 is used for color control purposes in a printing process in a printing machine 15. In general, the printing machine 15 is controlled by a workflow software system. FIG. 6 illustrates an offset printing machine 22 with its control computer 23 as an example of such a printing machine 15. This is a simplified illustration with two inking units. An offset printing machine 22 with four inking units is required for carrying out the disclosed method in four-color printing. Accordingly, for the implementation according to the invention in multicolor printing, the number of inking units present must be the same as the number of colors used. In this case, the control computer 23 of the printing machine 22 cooperates with the workflow system or operates the latter. Thus it makes sense to have the defined substitution colors saved and administered by the workflow system. In the preferred embodiment, the disclosed method for determining substitution colors for spot colors is sensibly integrated into the workflow software system. In detail, it is implemented as follows: spot colors in general are listed in tables 17, for example in Pantone tables such as “PANTONE Solid Coated®” with several hundreds of spot colors. Another example for such a color table 17 is diagrammatically shown in FIG. 4. It is now possible to calculate a substitution table 21 in advance for all of these spot colors defined colorimetrically for instance by a CIELAB value in combination with a specific paper. The workflow software system then checks the table 21 when a spot color is to be replaced. Customer-defined spot colors that are not available in tables 17 need to be calculated by the workflow system “on the fly” as needed. Another option is to calculate substitution colors only for the spot colors present in a document. This is what the Heidelberg Prinect® workflow system does, for instance.

The disclosed method will be explained again based on an example. A typical profile of a multicolor printing process including seven process colors C, M, Y, K 9, 10, 11, 12 as well as orange (0), blue (B), and green (G) 13, has been created by using the Prinect Color Toolbox, for instance. A typical spot color table 17 is Pantone Solid Coated® created by the Pantone company. In a conventional workflow system, based on the profile indicated above, the result for a brown spot color PANTONE 1605 C (L=42.8, a=34.7, b=47.5) is C=21.9%, M=7.3%, Y=42.2%, K=38.1%, O=90.5%, G=0%, B=0%, with a deviation between the spot color value and the value achievable in the printing process amounting to dE2000=0.2. The total area coverage of the five printing colors is 200%. In accordance with the method disclosed herein, based on the characterization data 19″ and the forward model, respectively, of the multicolor profile, a reduction to 2 chromatic colors and black 12 leads to C=0.0%, M=0.0%, Y=38.8%, K=50.4%, O=90.9%, G=0.0%, B=0.0%, with a deviation between the value of the spot color and the value achievable in the printing process amounting to dE2000=0.3. The total area coverage of the three printing colors is 180.1%. In a conventional workflow system, based on the profile above, the result for a blue spot color PANTONE 303 C (L=18.4, a=−14.9, b=−22.1) is C=100%, M=19.7%, Y=22.7%, K=75.5%, O=0%, G=0%, B=13.3%, with a deviation between the value of the spot color and the value achievable in the printing process amounting to dE2000=2.9. The total area coverage of the five printing colors is 231.2%. In accordance with the method disclosed herein, based on the characterization data 19″ and the forward model, respectively, of the multicolor profile, a reduction to 2 chromatic colors and black 12 leads to C=100.0%, M=0%, Y=0%, K=83.0%, O=0%, G=0%, B=7.9%, with a deviation between the value of the spot color and the value achievable in the printing process amounting to dE2000=2.2. The total area coverage of the three printing colors is 190.9%.

1. A method for calculating substitution colors for spot colors by using a computer for computer-aided color control of a four-color printing process in a printing machine, the method comprising the following steps:
creating a set of characterization data describing a relationship between tonal values of process colors CMYK being used and resultant printed color values, by using the computer;
adapting to the printing process and interpolating the set of characterization data by using the computer;
calculating the substitution colors including two chromatic and an achromatic color from the adapted and interpolated characterization data with a basic condition by using the computer; and
using the calculated substitution colors in the computer-aided color control of the four-color printing process to process a current print job.

2. The method according to claim 1, which further comprises:
establishing the characterization data by an evaluation of printed test elements in accordance with ISO 12642-2 with 1617 color fields;
carrying out the evaluation by measuring the printed test elements using color measuring devices; and
subsequently digitizing and saving the measured color values obtained in conjunction with the process colors CMYK used as a set of characterization data in a manner accessible to the computer.

3. The method according to claim 2, wherein the color measuring devices are densitometers and spectrometers.

4. A method for calculating substitution colors for spot colors by using a computer for computer-aided color control of a four-color printing process in a printing machine, the method comprising the following steps:
selecting a set of characterization data describing a relationship between tonal values of process colors CMYK being used and resultant printed color values, by using the computer, from a pool of existing, standardized sets of characterization data stored in a memory;
adapting to the printing process and interpolating the set of characterization data by using the computer;
calculating the substitution colors including two chromatic and an achromatic color from the adapted and interpolated characterization data with a basic condition by using the computer; and
using the calculated substitution colors in the computer-aided color control of the four-color printing process to process a current print job.

5. A method for calculating substitution colors for spot colors by using a computer for computer-aided color control of a four-color printing process in a printing machine, the method comprising the following steps:
selecting a suitable ICC profile, in which an assignment of tonal values of process colors CMYK being used to color spaces of resultant printed color values is saved in a tabular fashion, from a pool of existing standardized ICC profiles stored in a memory;
generating characterization data from the selected ICC profile by using the computer;
adapting to the printing process and interpolating a set of characterization data by using the computer;
calculating the substitution colors including two chromatic and an achromatic color from the adapted and interpolated characterization data with a basic condition by using the computer; and
using the calculated substitution colors in the computer-aided color control of the four-color printing process to process a current print job.

6. A method for calculating substitution colors for spot colors by using a computer for computer-aided color control of a four-color printing process in a printing machine, the method comprising the following steps:
creating a multicolor profile of characterization data describing a relationship between tonal values of process colors CMYK being used and resultant printed color values by using the computer;
adapting to the printing process and interpolating the multicolor profile of characterization data by using the computer;
calculating the substitution colors including two chromatic and an achromatic color from the adapted and interpolated multicolor profile with a plurality of basic conditions by using the computer; and
using the calculated substitution colors in the computer-aided color control of the multicolor printing process to process a current print job.

7. The method according to claim 6, which further comprises:
establishing the characterization data by an evaluation of minimized printed test elements;
carrying out the evaluation by measuring the printed test elements using measuring devices;
subsequently digitizing and saving the measured color values obtained in conjunction with the process colors CMYK being used as a set of characterization data in a manner accessible to the computer; and
calculating missing color values of the minimized printed test element by the computer using segmented spectral Neugebauer equations.

8. The method according to claim 7, wherein the measuring devices are densitometers and spectrometers.

9. The method according to claim 1, which further comprises calculating missing color values for the calculation of the substitution colors by multilinear interpolation.

10. The method according to claim 4, which further comprises calculating missing color values for the calculation of the substitution colors by multilinear interpolation.

11. The method according to claim 5, which further comprises calculating missing color values for the calculation of the substitution colors by multilinear interpolation.

12. The method according to claim 6, which further comprises calculating missing color values for the calculation of the substitution colors by multilinear interpolation.

13. The method according to claim 1, which further comprises saving the determined substitution colors in a table for use in a workflow system.

14. The method according to claim 4, which further comprises saving the determined substitution colors in a table for use in a workflow system.

15. The method according to claim 5, which further comprises saving the determined substitution colors in a table for use in a workflow system.

16. The method according to claim 6, which further comprises saving the determined substitution colors in a table for use in a workflow system.

17. The method according to claim 1, which further comprises integrating the method into a workflow system as an integral component.

18. The method according to claim 4, which further comprises integrating the method into a workflow system as an integral component.

19. The method according to claim 5, which further comprises integrating the method into a workflow system as an integral component.

20. The method according to claim 6, which further comprises integrating the method into a workflow system as an integral component.
